(19) United States
(12) Patent Application Publication
(10) Pub. No.: US 2019/0090450 A1
(43) Pub. Date: Mar. 28, 2019

(54) CUSTOM PET TRAY

(71) Applicant: Devon Moore, Tustin, CA (US)

(72) Inventor: Devon Moore, Tustin, CA (US)

(21) Appl. No.: 16/132,269

(22) Filed: Sep. 14, 2018

Related U.S. Application Data
(60) Provisional application No. 62/558,837, filed on Sep. 14, 2017.

(51) Int. Cl. A01K 1/01

(52) U.S. Cl. CPC A01K 1/0107

(57) ABSTRACT

A custom pet tray apparatus adapted to be elevated vertically above a surface upon which the custom pet tray apparatus may be disposed employing a plurality of feet. In one embodiment, the custom pet tray apparatus may also comprise at least one channel configured to provide mechanical structural integrity to the custom pet tray.

This non provisional U.S. patent application claims the benefit of priority to earlier filed U.S. provisional patent application having Ser. No. 62/558,837 entitled, “CUSTOM PET TRAY”, filed Sep. 14, 2017 and is hereby incorporated by reference.

### BACKGROUND

### Field

The present invention relates generally to a tray for effectively supporting health and cleanliness issues associated with domesticated animals living in high density human population centers in modern society.

### Related Art

For thousands of years, humans have domesticated animals for a wide variety of purposes, including transportation, food, farming, and companionship. The domestication of animals for companionship has been shown to have significant health benefits to humans, including physical protection, affection, purpose and a pure sense of unconditional love that is often missing from human relationships. Indeed, the affection of a cat purring, or a dog's excitement when the owner comes home has been scientifically shown to lower blood pressure, reduce stress levels, reduce cortisol, release serotonin in the brain, and provide a general sense of well-being to the human owner of the domesticated pet.

Population density of humans has exponentially increased over the last two millennia, such that urban centers of human habitation have needed to be planned more efficiently, in order to conserve space. That is, humans have developed greater vertical spaces for living, in order to economize space, such as for example apartments and condominiums. In order to more efficiently provide living space to higher population densities, society has increased vertical spaces for living, in order to preserve other spaces for parks, stores, restaurants, and the like, however this has led to a reduction in the amount of yard spaces typically associated with houses, wherein pets often are able to roam and eliminate biological waste products.

Many people with domesticated pets who do not have a yard have used synthetic turf or potty pads for a potty solution inside the home or on their apartment or condominium patio. Many pet owners have complained of the constant smell of urine, the run off of urine onto other apartment patios when trying to clean synthetic turf, and the hassle of cleaning up pools of urine that potty pads were unable to absorb.

The present teachings disclose methods and apparatuses that address these concerns. The present teachings solve these problems, as will now be described.

### BRIEF DESCRIPTION OF THE DRAWINGS

Embodiments of the present disclosure will be more readily understood by reference to the following figures, in which like reference numbers and designations indicate like elements.

FIG. 1 is a schematic view of one embodiment of the present teachings.

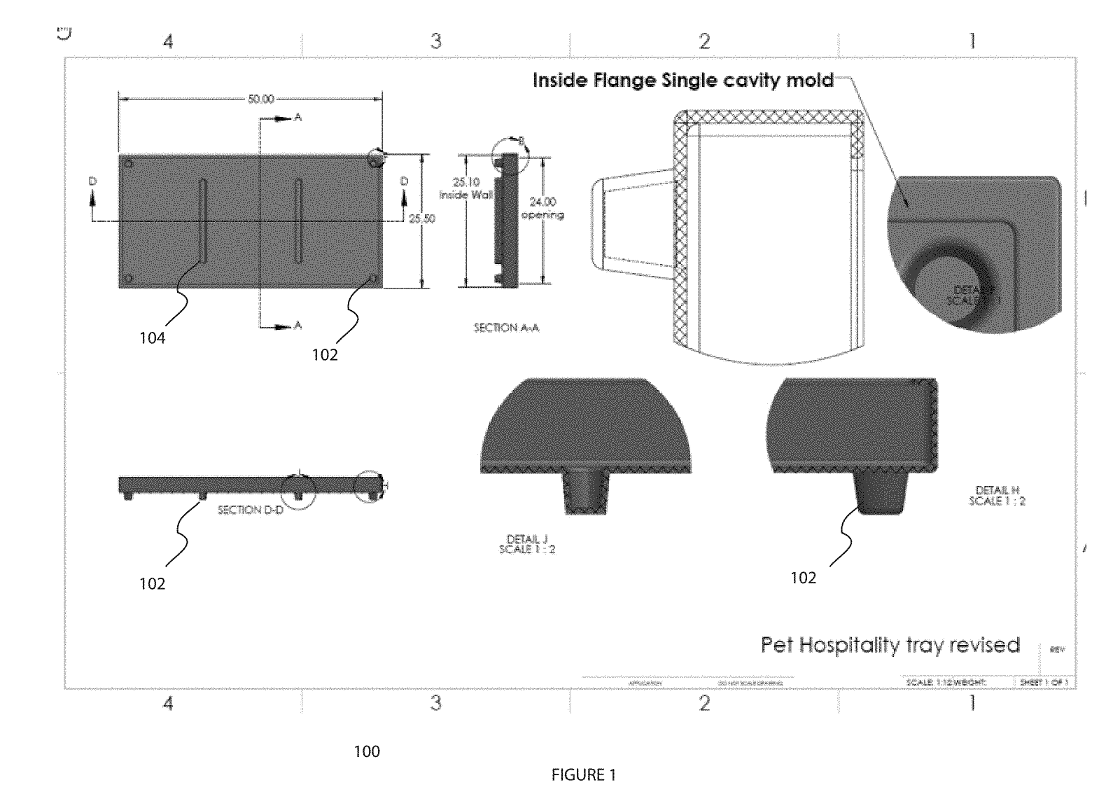

FIG. 2a is a perspective view of one embodiment of the present teachings.

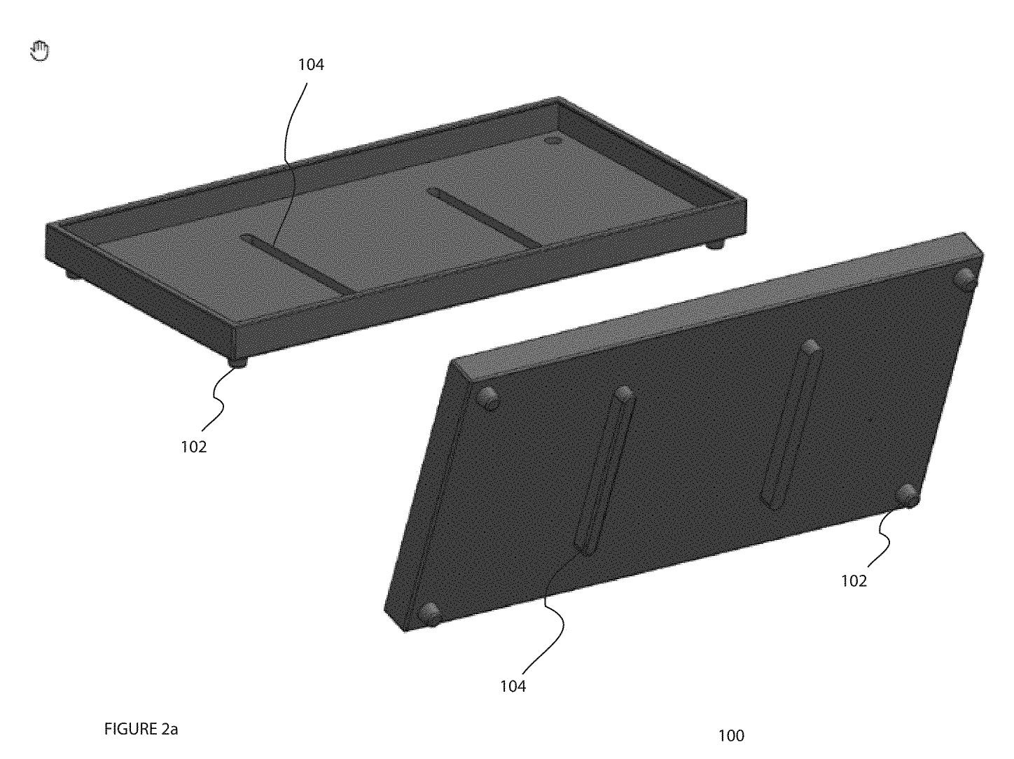

FIG. 2b is a top perspective view of one embodiment of the present teachings.

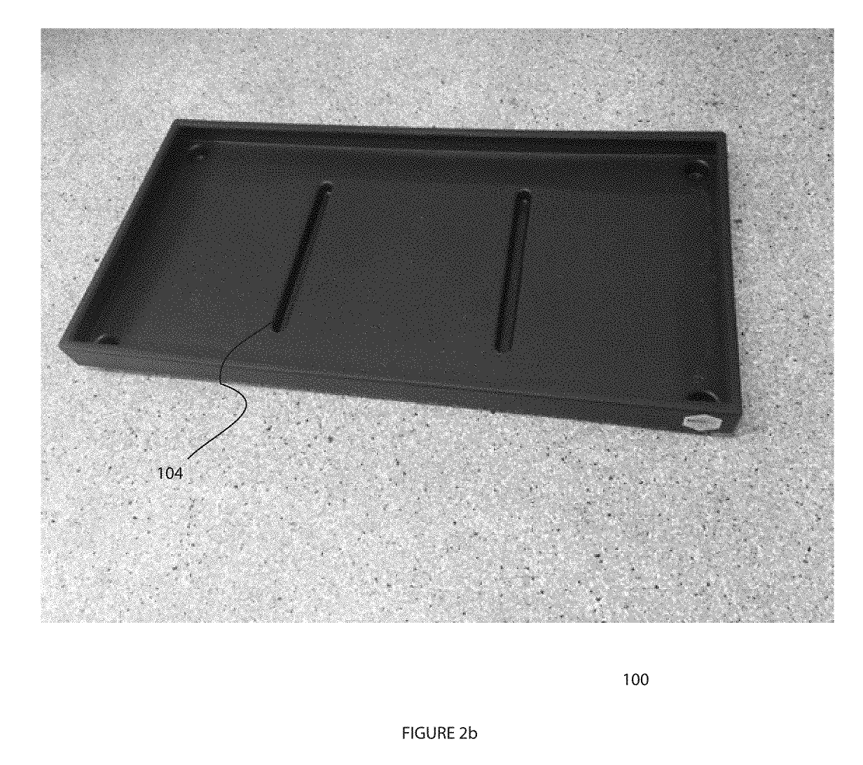

FIG. 2c is a bottom perspective view of one embodiment of the present teachings.

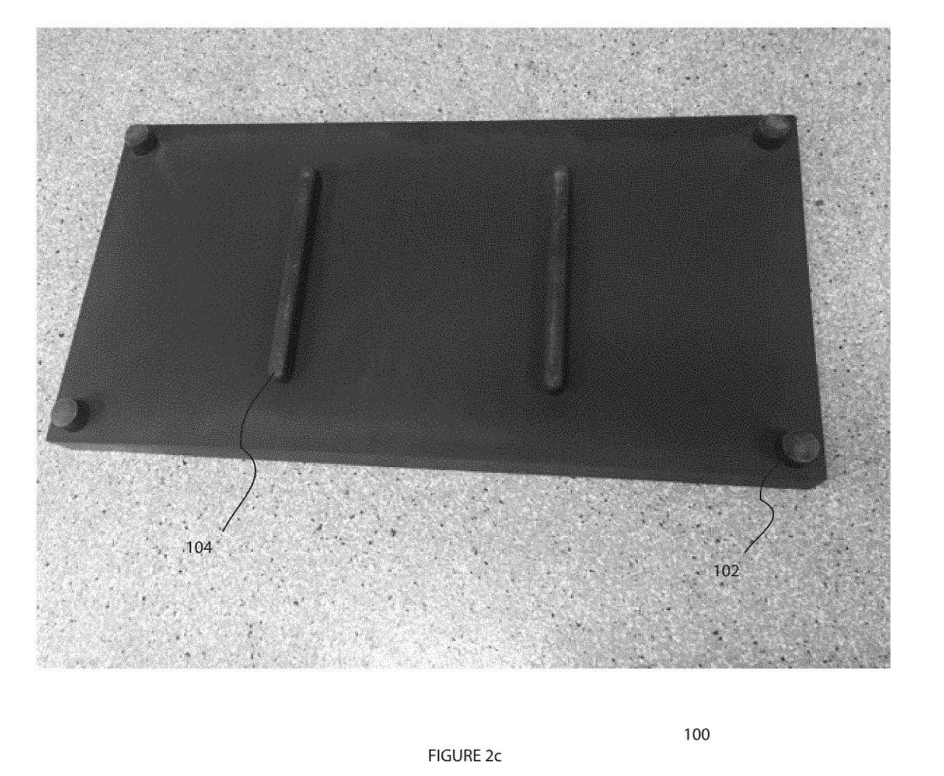

FIG. 3 is a top perspective view of one alternate embodiment of the present teachings, showing an element of the invention.

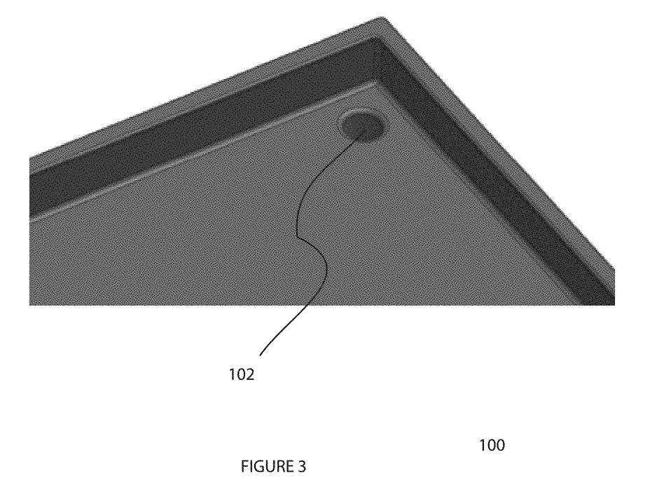

FIG. 4 illustrates one embodiment of the present teachings, of a schematic view of elements of the invention.

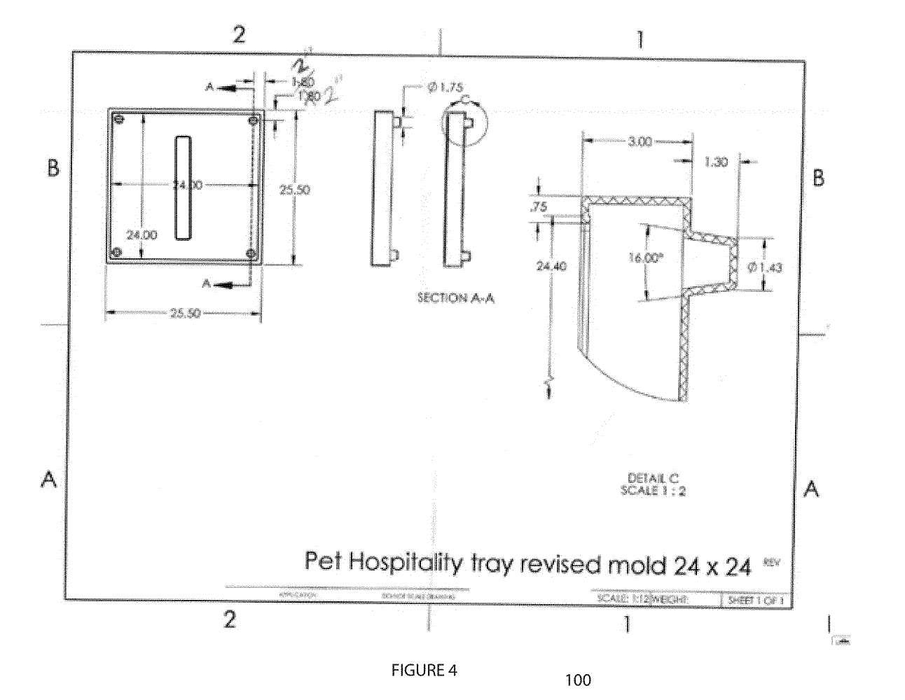

FIG. 5 is a side perspective view of one alternate embodiment of the present teachings.

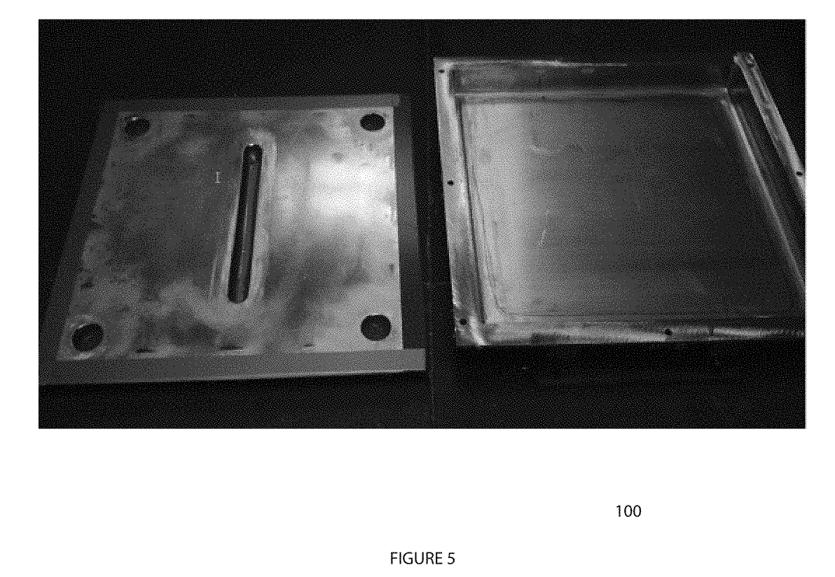

FIG. 6 is a side plan view of one alternate embodiment of the present teachings.

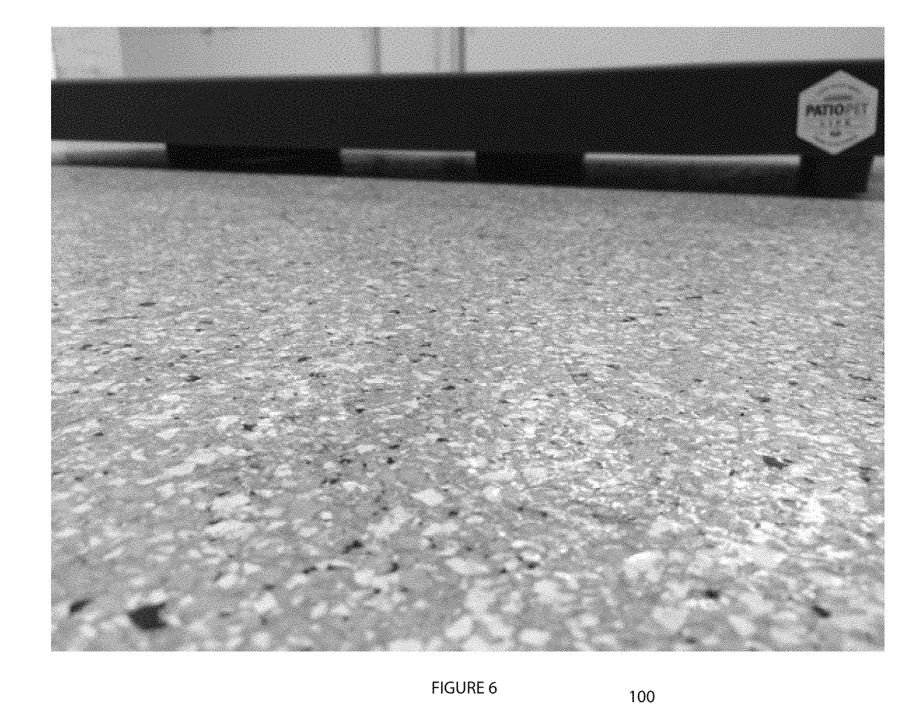

FIG. 7a is a top perspective view of one alternate embodiment of the present teachings.

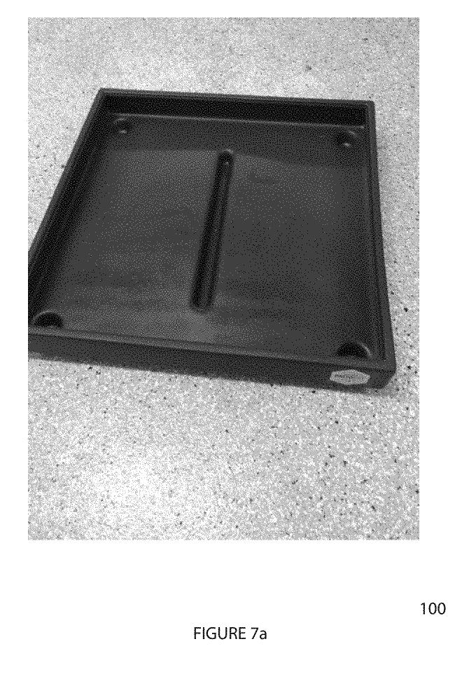

FIG. 7b is a bottom perspective view of one alternate embodiment of the present teachings.

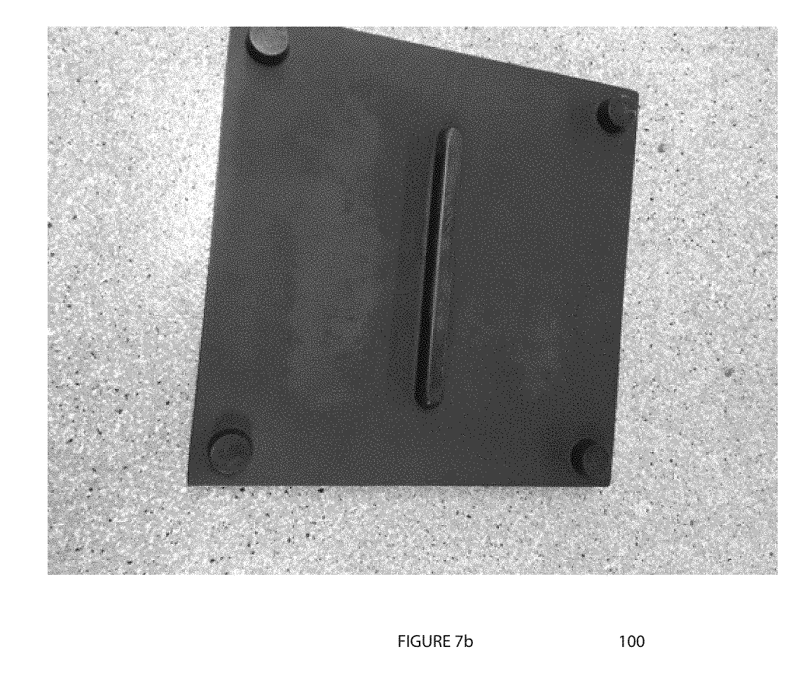

FIG. 8 is a side perspective view of one alternate embodiment of the present teachings.

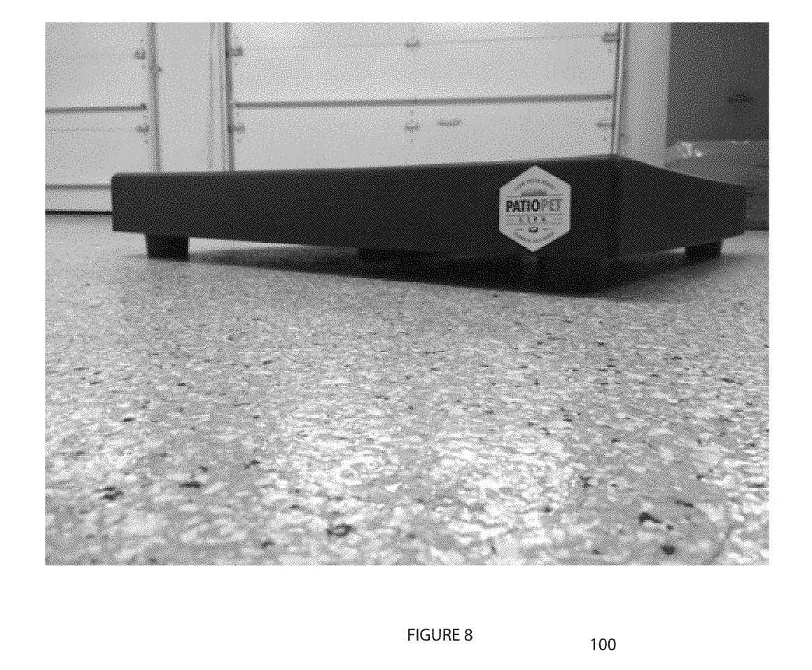

### DETAILED DESCRIPTION

Embodiments of the present teachings focus on supporting the health and sanitary aspects of domesticated animals in biological waste elimination.

Although apparatuses for pets to eliminate waste have been in the current state of the art in the recent past, one major issue with such apparatuses has been that waste products essentially pool, such as for example with urine, wherein upon multiple visits to waste elimination apparatuses, the pet is required to stand in a pool of its own urine, which can lead to health issues, and general undesirable sanitary conditions, such as the animal tracking urine about the household. Once urine has been tracked about the household, this can lead to the animal potentially desiring to urinate in a location of the home not intended for such use, because the scent has been tracked through the home.

The custom pet tray apparatus of the present teachings address the aforementioned issues in multiple ways. In one embodiment, the custom pet tray may use actual real grass, which may be hydroponically grown, such that the real grass will more readily absorb biological waste of the pet through absorption, in a manner superior to the commonly used artificial grass. Moreover, as pets are sensitive to smells, natural grass further supports the animal's natural inclination to use the grass for the intended purposes of confining waste products to the custom pet tray. The custom pet tray makes the use of real grass for a pet's waste much easier and cleaner because of the tray's ability to contain the grass. Having this tray as an option eliminates other less pleasant waste solutions such as synthetic turf and potty pads.

In one embodiment, ash shown in the Figures, the custom pet tray 100 can be used outdoor and indoor as there is no drainage system necessary as the grass absorbs liquid and odor. The feet 102 on the bottom of the tray raise it up off the ground for easy cleaning underneath. Without the drainage and with the feet to raise it off the ground, this tray provides a pet potty that minimizes cleaning of liquid waste since a significant portion of urine is absorbed by the natural grass compared with artificial grass, does not have any urine run off, and does not need to be lifted or moved to clean the surface underneath the custom pet tray. As shown in the Figures, another aspect of the present teachings is providing a channel 104 and/or cavities underneath the grass, which provide additional structural integrity to the custom pet tray, by displacing the downward mechanical force on the custom pet tray, if a larger animal (e.g., bigger dog) requires the use of the custom pet tray.

Although it does not need to be moved to clean underneath because of it being raised off the ground, its lightweight nature makes it easily movable if needed. They are UV protected to maintain its attractive appearance, although not required to create the look and functionality of the tray. Although the current color of the tray is chocolate brown, they may also differ in color to compliment one's patio décor.

In some embodiments, the custom pet trays are available various sizes, for example, large—50″×25.5″ and small—25″×25″, yet can be made to fit any custom size piece of grass. Made by a process called rotational molding or injection molding, they are made from a durable, yet lightweight material called polyethylene or ABS, with the large tray weighing 10 pounds and the small tray weighing 5.5 pounds. The large tray has 2 cavities, while the small tray has one cavity to strengthen the support of the tray and to prevent bowing.

The custom pet trays may contain an optional drain hole(s) with plugs, therefore continuing to allow them to be used indoors as well as outdoors for those that may choose to thoroughly water the real grass, use artificial turf instead or just to hose down the tray from time to time. They may also be used to hold other pet related products such as a cooling dog bed for the patio or a regular dog bed inside. The tray may also have the option to add on a shade attachment for warm weather months. The tray may also be a universal size that can start as the Small Tray and extend out to the Large Tray as your pet grows and needs more space. The tray may have a side that can fold down to allow easy step in for a smaller pet or to slide the grass in and out. The tray cavities may be round, square or simply feet in its place without a cavity.

The foregoing description illustrates exemplary implementations, and novel features, of aspects of a custom pet tray apparatus and method. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

What is claimed is:

1. A custom pet tray apparatus, having a lower side and four rigid adjacent sides mechanically coupled to the lower side, comprising:
a plurality of feet, disposed upon the lower side of the custom pet tray, configured to provide distance between the lower side of the custom pet tray and a surface upon which the custom pet tray may be disposed, and;
at least one channel, disposed upon the lower side of the custom pet, wherein the at least one channel is configured to provide mechanical structural integrity to the custom pet tray.
